(19) United States
(12) Patent Application Publication
(10) Pub. No.: US 2010/0060534 A1
(43) Pub. Date: Mar. 11, 2010

(54) ANTENNA DEVICE

(75) Inventor: Noriaki Oodachi, Kanagawa-ken (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/556,000

(22) Filed: Sep. 9, 2009

(30) Foreign Application Priority Data
Sep. 9, 2008 (JP) 2008-230746

(51) Int. Cl. H01Q 3/00; H01Q 1/00

(52) U.S. Cl. 343/745

(57) ABSTRACT

An antenna device includes a reflector plate, plane conductors, an antenna element, variable impedance elements, control wires and linear conductors. The plane conductors are arranged regularly on a plane which is parallel to the reflector plate. The antenna element is set on the plane, to be parallel to the reflector plate. The variable impedance elements provide a directivity to the antenna element, the directivity is radiating a wave strongly to a particular direction. Each control wire supplies a control signal to each of the variable impedance elements. Each linear conductor connects each of some plane conductors with the reflector plate. Moreover, each of the other plane conductors is connected to the reflector plate through a portion of each control wire instead of the linear conductor.

### CROSSREFERENCE TO RELATED APPLICATIONS

This application is based upon and claims the benefit of priority from the Japanese Patent Application No. 2008-230746, filed on Sep. 9, 2008, the entire contents of which are incorporated herein by reference.

### BACKGROUND OF THE INVENTION

1. Field of the Invention

The present invention relates to an antenna device.

2. Description of the Related Art

Low profile antennas are desired in wireless communications for airplanes and small equipments such as cell phone because they could reduce air resistance and achieve more mobility. One of the antenna devices with low profile is disclosed in Japanese Patent No. 3653470, which is corresponding to WO99/050929 A1. This antenna device applies an EBG (Electromagnetic Band Gap) ground plane. The EBG ground plane includes several plane conductors and a reflector plate with conduction. Each plane conductor is connected to the reflector plate through a linear conductor. The pairs of the plane conductor and the linear conductor are arranged regularly.

On the other hand, variable directional antennas are also desired in order to gain a higher received power. One of the variable directional antennas is a tunable antenna with variable impedance. The tunable antenna requires a control wire for controlling the variable impedance.

An antenna, which has both low profile and variable direction, could be realized by combining the EBG ground plane and the tunable antenna. In order to obtain such antenna device, the control wire for controlling the variable impedance should be inserted between the plane conductors and the reflector plate. However, the control wire disarranges the regular configuration of the plane conductor and the linear conductor. As a result, the performance of the EBG ground plane may be degraded.

### SUMMARY OF THE INVENTION

According to one aspect of the invention, an antenna device includes:
a reflector plate;
plane conductors arranged regularly on a plane which is parallel to the reflector plate;
an antenna element set on the plane, to be parallel to the reflector plate;
variable impedance elements which provide a directivity to the antenna element, the directivity being radiating a wave strongly to a particular direction;
control wires, each supplying a control signal to each of the variable impedance elements; and
linear conductors provided for some plane conductors, each connecting each of some plane conductors with the reflector plate,
   wherein each of the other plane conductors is connected to the reflector plate through a portion of each control wire instead of the linear conductor.

### BRIEF DESCRIPTION OF THE DRAWINGS

FIG. 1 is a perspective view of the antenna device according to the first embodiment;

FIG. 2 is a cross-sectional view of the antenna device along the line A-A in FIG. 1;

FIG. 3 is a cross-sectional view of the antenna device along the line B-B in FIG. 1;

FIG. 4 is a cross-sectional view of the antenna device along the line C-C in FIG. 1;

FIG. 5A is a top view of the antenna device in FIG. 1, when the direction of the antenna is Y-direction;

FIG. 5B is a top view of the antenna device in FIG. 1, when the direction of the antenna is X-direction;

FIG. 6 is a top view of the antenna device according to the second embodiment; and

FIG. 7 is a cross-sectional view of the antenna device according to the third embodiment.

### DETAILED DESCRIPTION OF THE INVENTION

The embodiments will be explained with reference to the accompanying drawings.

### Description of the First Embodiment

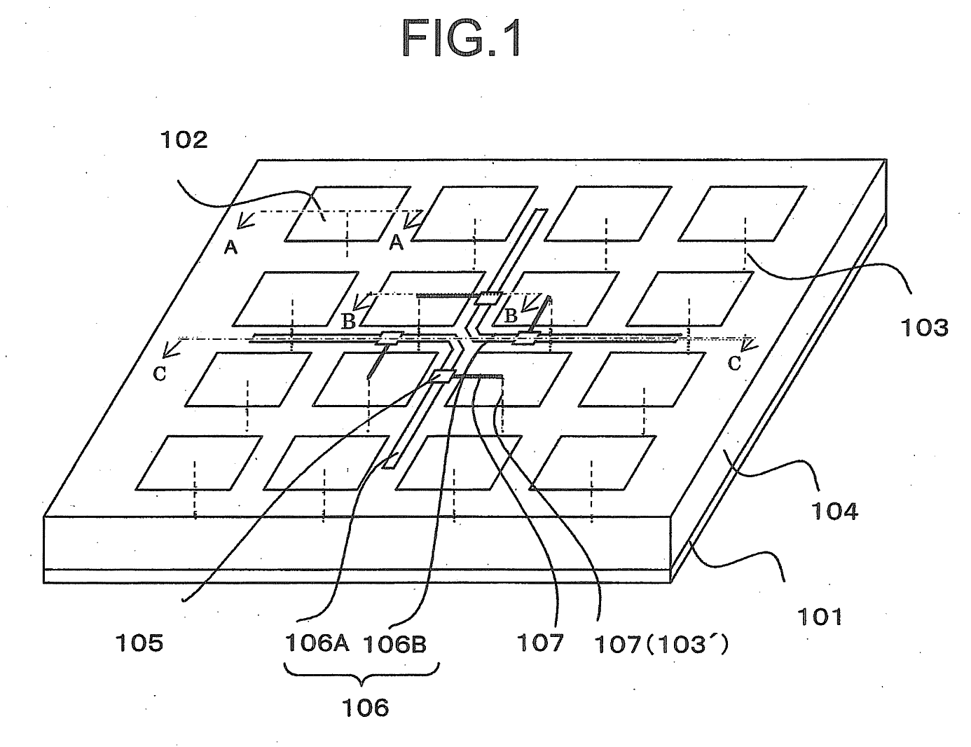

As shown in FIG. 1, an antenna device includes a reflector plate 101, plane conductors 102, linear conductors 103, a first insulation layer 104, an antenna element 106, a variable impedance element 105 which provides a directional attribute to the antenna element 106, and a control wire 107 which is used for controlling the variable impedance element 105. The reflector plate 101, the plane conductors 102, the linear conductors 103, and the first insulation layer 104 provide the EBG ground plane.

Moreover, the variable impedance element 105, the antenna element 106, and the control wire 107 provide the tunable antenna. Each plane conductor 102 is set parallel to the reflector plate 101 and connected to the reflector plate 101 through the linear conductor 103. The pairs of the plane conductor 102 and the linear conductor 103 are arranged regularly.

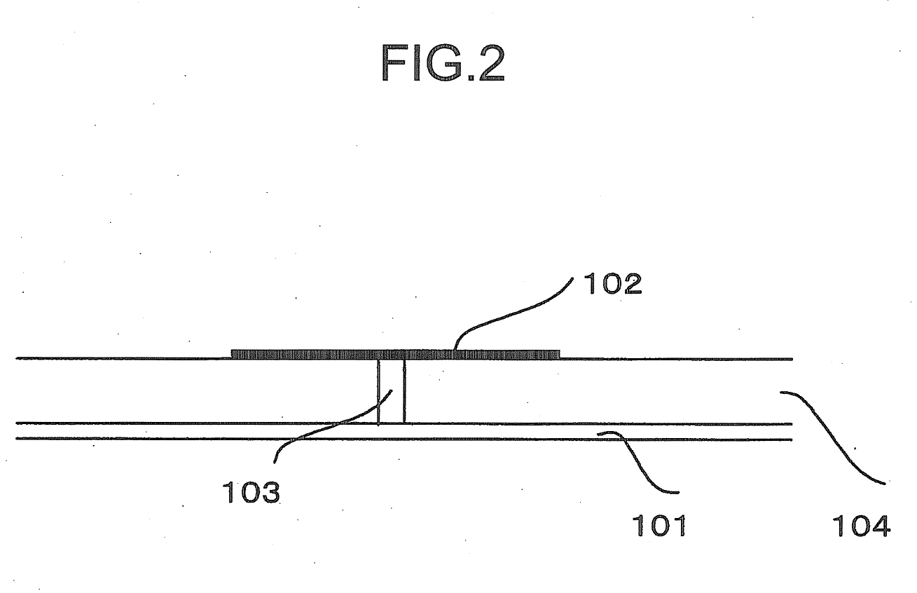

FIG. 2 is a cross-sectional view of the antenna device along the line A-A in FIG. 1. The linear conductor 103 is used to connect the plane conductor 102 and the reflector plate 101. In FIG. 2, although the linear conductor 103 is set orthogonally between the reflector plate 101 and the plane conductor 102, it could be set with other angle such as 45°.

The reflector plate 101 is conductive and may be made of metal such as copper. A thickness of the reflector plate 101 is preferable to be thinner compared with a wavelength due to an operating frequency of the antenna element 106. For example, when the wavelength is about 300 [mm] due to the operating frequency of 1 [GHz], the thickness of the reflector plate 101 is preferable to be about 0.1 [mm]˜1.0 [mm].

In the first embodiment, a shape of the plane conductor 102 is square to have same shape, same size and same thickness. The plane conductors 102 could have other shape such as rectangle, regular triangle, and hexagonal. The plane conductors 102 are periodically placed with keeping a fixed distance and parallel to each other. In the first embodiment, the plane conductor 102 is made of the same material with the same thickness as the reflector plate 101.

It is preferable that all linear conductors 103 have same shape and same size. In the first embodiment, the shape of the linear conductor 103 is straight line. In other case, the shape of the linear conductor 103 may be other shape such as cylinder and cube.

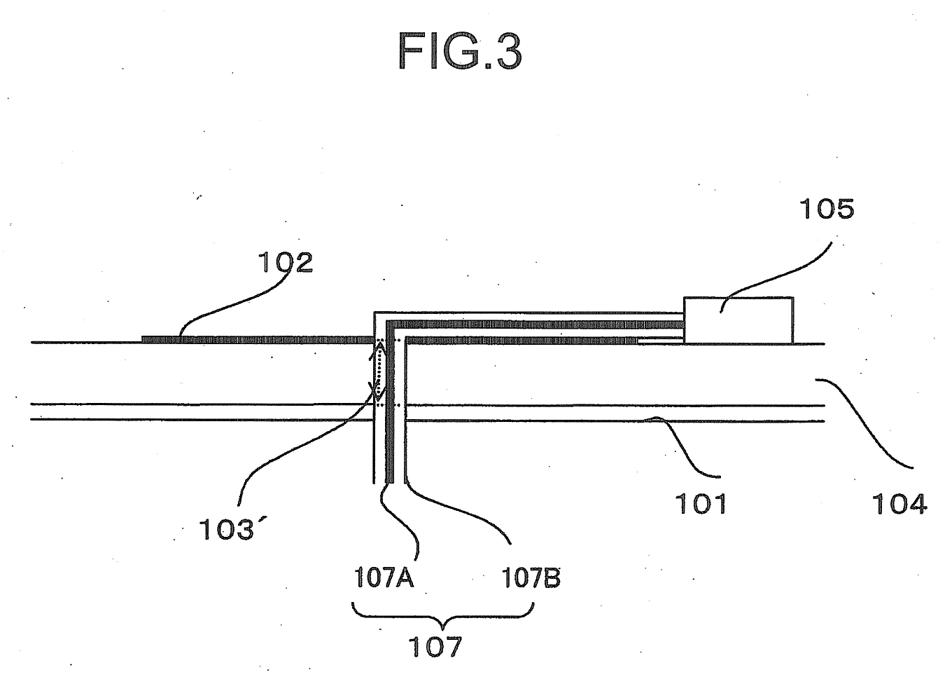

FIG. 3 is a cross-sectional view of the antenna device along the line B-B in FIG. 1. The control wire 107 includes an inner conductor 107A and an outer conductor 107B. The inner conductor 107A is concentrically covered with the outer conductor 107B. Both the inner conductor 107A and the outer conductor 107B have an L-shape. One piece of the L-shape is along the plane conductor 102 and appears on the plane conductor 102. The other piece of the L-shape is perpendicular to the plane conductor 102 as same as the linear conductor 103, and passes through the reflector plate 101.

One terminal of the inner conductor 107A is connected to the variable impedance element 105, and the other terminal of the inner conductor 107A is connected to a circuit for wireless communication (not shown). The circuit for wireless communication controls the variable impedance element 105 by sending an indication through the inner conductor 107A.

Each plane conductor 102 has either the linear conductor 103 or the control wire 107. When the plane conductor 102 has the control wire 107, a portion 103′ of the outer conductor 107B (hereinafter, “outer portion 103′”) is also used to connect the plane conductor 102 and the reflector plate 101 instead of the linear conductor 103. The outer portion 103′ is set at same location of the linear conductor 103 and connects orthogonally the plane conductor 102 and the reflector plate 101.

All outer conductors 107B have same shape and same size. Moreover, the outer portion 103′ has the same shape and size as the linear conductor 103.

As a result, the outer portion 103′ has same configuration, shape, and size as the linear conductor 103. Therefore, when the plane conductor 102 has the control wire 107, the outer portion 103′ is used as both the linear conductor 103 and the outer conductors 107B.

A shape and size of the outer conductor 107B could have variations, as long as they are same as the linear conductor 103.

Moreover, the other portion of the outer conductor 107B is better to be along the plane conductor 102 with no space as shown in FIG. 3. This is because that it can avoid generating electric field between the control wire 107 and the plane conductor 102. The electric field may be led to degrade the performance of the EBG ground plane.

As shown in FIG. 1, the antenna element 106 is set parallel to the reflector plate 101 with space from the plane conductors 102.

In FIG. 1, the antenna element 106 includes two sub antenna elements 106A and 106B. Each sub antenna element has two variable impedance elements 105. The number of the sub antenna elements and the number of the variable impedance elements 105 are not limited above number.

The antenna element 106 is better to be made of the same material of the plane conductors 102, and have a same thickness of the plane conductors 102. This is because that the antenna element 106 and the plane conductors 102 can be produced with a same method.

In the first embodiment, the sub antenna elements 106A and 106B are directed to different directions, respectively. This configuration provides switching the direction of polarization. The detail is described later.

In the first embodiment, the variable impedance element 105 is a switch element which selects 0[Ω] (short) or ∞ [Ω] (open) as an impedance value. This variable impedance element 105 above allows variable polarization and variable operating frequency.

In other example, the variable impedance element 105 may be an element which allows to vary an inductance value and a capacitance value. This variable impedance element 105 allows to vary direction of a maximum radiation.

In other example, the variable impedance element 105 may be a combination of elements which allow to vary an inductance value, a capacitance value, and a resistance value, respectively. This variable impedance element 105 allows to vary direction of a maximum radiation with extending a bandwidth to be used for the antenna.

For example, the variable impedance element 105 is realized by using a technology of MEMS (Micro Electro Mechanical System). Also, the variable impedance element 105 may be realized by using a varicap diode and a FET switch.

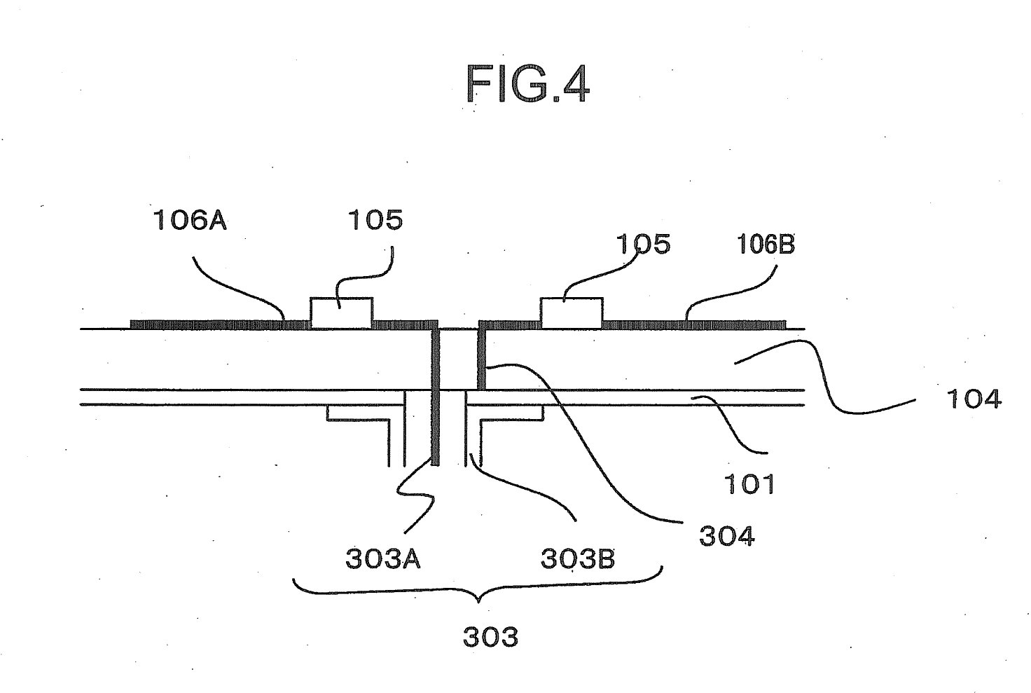

FIG. 4 is a cross-sectional view of the antenna device along the line C-C in FIG. 1. The antenna device has a coaxial feeder line 303. The coaxial feeder line 303 supplies electricity to the antenna element 106. The coaxial feeder line 303 includes an inner conductor 303A and an outer conductor 303B.

The inner conductor 303A and the outer conductor 303B are coaxially arranged with space from each other. One terminal of the inner conductor 303A is connected to the antenna element 106A. The other terminal of the inner conductor 303A is connected to the circuit for wireless communication (not shown). On the other hand, one terminal of the outer conductor 303B is connected to the reflector plate 101.

A short-cut element 304 is inserted between the reflector plate 101 and the antenna element 106B. The short-cut element is a conductor through which electricity flows among the sub antenna element 106B, the reflector plate 101 and the outer conductor 303B.

Since the antenna element 106 is supplied the electric power from two points; the coaxial feeder line 303 and the short-cut element 304, it is balanced-feed. On the other hand, in the case of no short element 304, it is unbalanced-feed.

In the first embodiment, the coaxial feeder line 303 is located in the middle of each sub antenna element 106A, 106B. The inner conductor 303A supplies electricity to the sub antenna element 106A.

Then, electricity is also flowed on the sub antenna element 106B because the sub antenna element 106B resonates and be coupling with the antenna element 106A. Therefore, both sub antenna elements 106A and 106B are fed electricity by the coaxial feeder line 303.

A space between the reflector plate 101 and the plane conductor 102 is filled with a first insulation layer 104. The first insulation layer 104 may be dielectric material, or magnetic material, or mixing dielectric and magnetic material.

According to the first embodiment, each plane conductor 102 is connected to the reflector plate 101 through either the linear conductor 103 or the control wire 107. In the case of the plane conductor 102 with the control wire 107, the control wire 107 works as the linear conductor 103 in addition to working as the control wire 107.

Since the control wire 107 and the linear conductor 103 share the outer portion 103′, the control wire 107 does not disarrange the regular configuration of the plane conductor 102 and the linear conductor 103.

As a result, the degradation of the performance in the EBG ground plane, which is due to inserting the control wire 107 for the tunable antenna, is avoided.

Hereinafter, we will explain the mechanism for realizing directional antenna at the antenna device in the first embodiment by changing a polarization, that is a vertical polarization or a horizontal polarization.

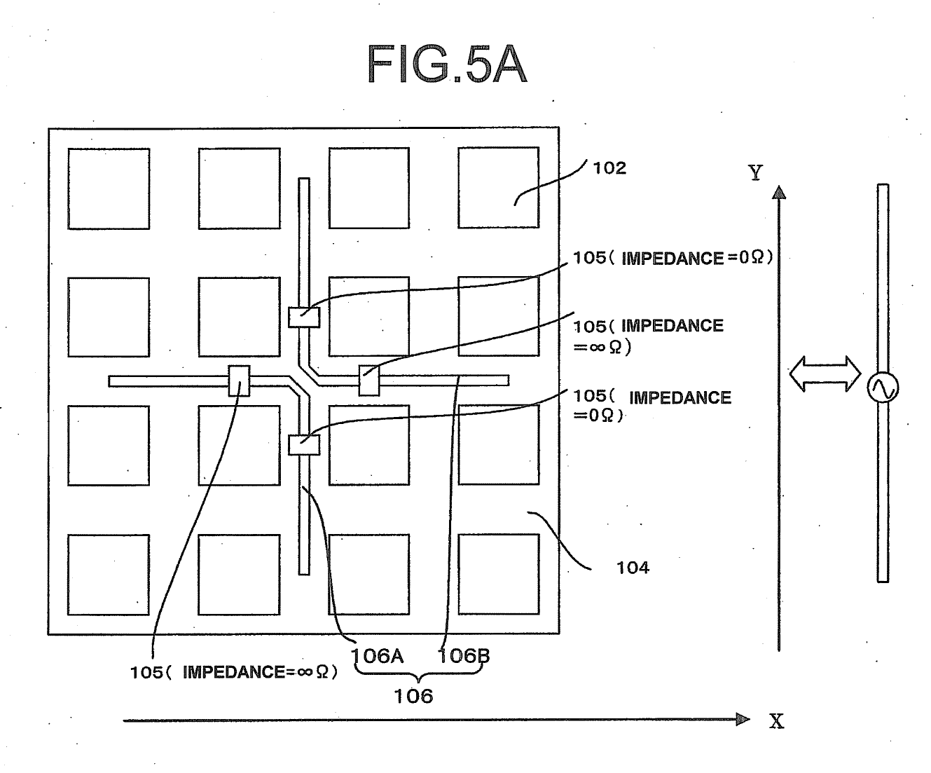

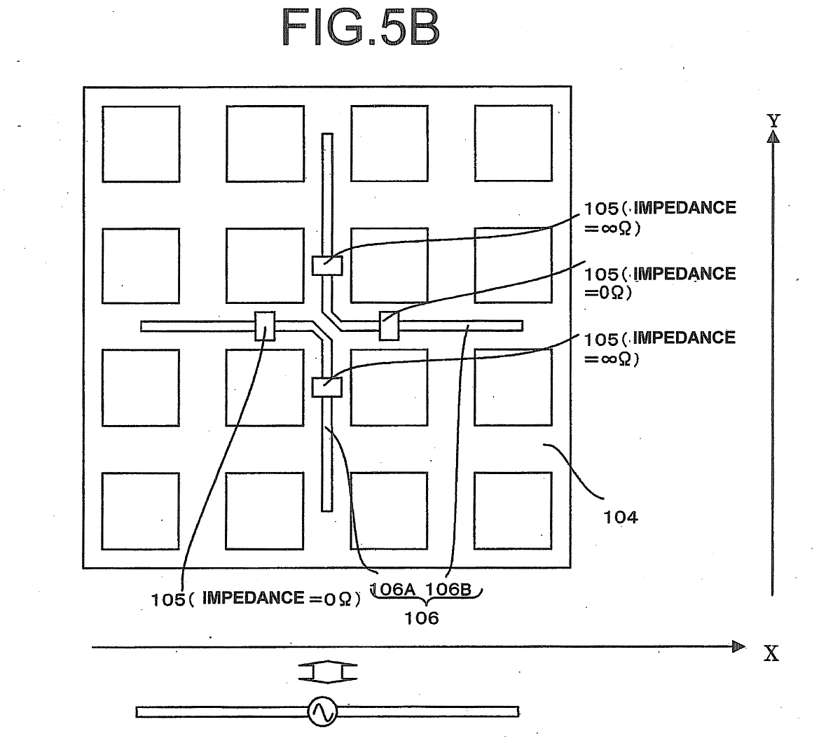

In FIGS. 5A and 5B, the sub antenna elements 106A and 106B are directed to different directions, respectively. Each sub antenna element 106A, 106B is L-shaped including two pieces. One piece of the sub antenna element 106A and one piece of the sub antenna element 106B are located in an alignment (hereinafter, “X-direction”). On the other hand, the other piece of the sub antenna element 106A and the other piece of the sub antenna element 106B are located in another alignment (hereinafter, “Y-direction”).

Each piece of the sub antenna element 106A, 106B has the variable impedance element 105. Therefore, the variable impedance elements 105 on one piece of the sub antenna element 106A and one piece of the sub antenna element 106B are located in the X-direction. Similarly, the variable impedance elements 105 on the other piece of the sub antenna element 106A and the other piece of the sub antenna element 106B are located in the Y-direction.

The variable impedance element 105 is a switch element which selects 0[Ω] (short) or ∞ [Ω] (open) as an impedance value. This variable impedance element 105 above allows variable polarization and variable operating frequency.

In FIG. 5A, the two variable impedance elements 105 in the Y-direction are set as 0[Ω] (short). On the other hand, the two variable impedance elements 105 in the X-direction are set as ∞ [Ω] (open). Therefore, the antenna element 106 works as a dipole antenna with a direction of the Y-direction.

In FIG. 5B, the two variable impedance elements 105 in the Y-direction are set as ∞ [Ω] (open). On the other hand, the two variable impedance elements 105 in the X-direction are set as 0[Ω] (short). Therefore, the antenna element 106 works as the dipole antenna with the direction of the X-direction.

According to FIGS. 5A and 5B, the antenna device provides switching the direction of a polarization between the X-direction and the Y-direction. The dipole antenna with the direction of the Y-direction generates a vertical polarization. The dipole antenna with the direction of the X-direction generates a horizontal polarization. Therefore, the antenna device achieves variable direction by switching the direction of the polarization.

As a result, the antenna device in the first embodiment, realizes both low profile and variable direction without the degradation of the performance of the EBG ground plane.

### Description of the Second Embodiment

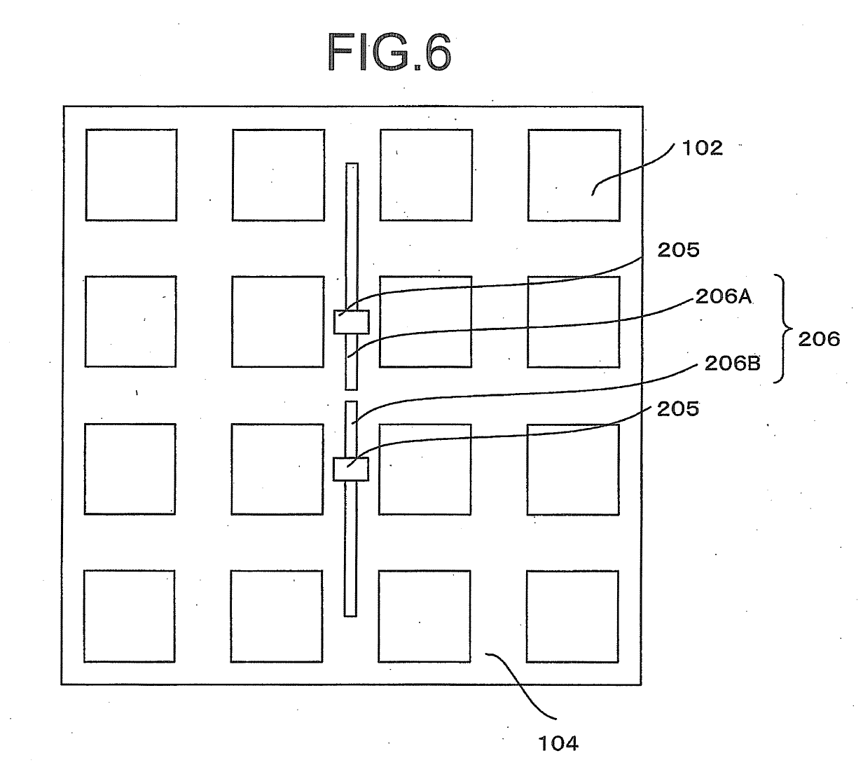

As shown in FIG. 6, the antenna device is almost same as that in the first embodiment, except a tunable antenna. Therefore, we will mainly explain the tunable antenna including an antenna element 206 and a variable impedance element 205 below.

The antenna element 206 includes sub antenna elements 206A, 206B. In the second embodiment, the shape of the sub antenna elements 206A, 206B is rectangle, and these sub antenna elements 206A, 206B are located along with a line. Each of the sub antenna elements 206A, 206B has a variable impedance element 205 therebetween.

A direction of a maximum radiation of the antenna element 206 is determined depending on a phase of a high frequency current through the sub antenna elements 206A, 206B. On the other hand, the variable impedance elements 205 can change a phase of the high frequency current, so that the direction of the maximum radiation of the antenna element 206 can be changed.

Moreover, the variable impedance elements 205 can also change a resonant frequency which is an operating frequency of the antenna element 206. This means that the antenna device can adjust the operating frequency of the antenna element 206.

Therefore, the antenna device realizes both low profile and variable direction without the degradation of the performance of the EBG ground plane.

The shape and/or the alignment of the sub antenna elements 206A, 206B are not limited above. The number of the variable impedance elements may be provided two or more for each sub antenna element.

### Description of the Third Embodiment

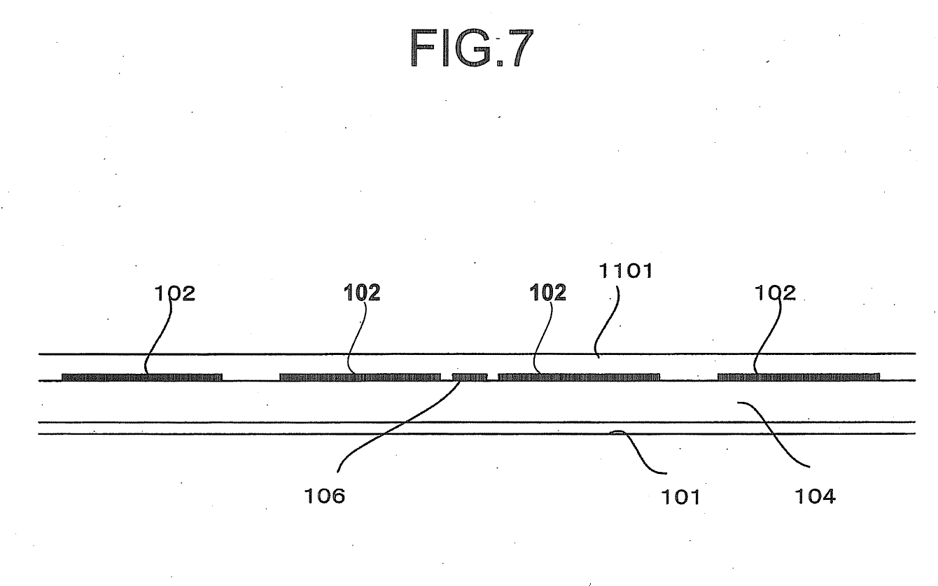

FIG. 7 is a cross-sectional view of the antenna device according to the third embodiment. The antenna device is same as that in the first embodiment, except that a second insulation layer 1101 exists. Therefore, we will mainly explain the second insulation layer 1101 below.

The first insulation layer 104 is along the reflector plate 101 with no space. The second insulation layer 1101 is set parallel to the reflector plate 101. The antenna element 106 is inserted between the first insulation layer 104 and the second insulation layer 1101 so as to radiate a radio wave to a medium except for air.

When the medium except for air exist around the antenna element 106 without the second insulation layer 1101, the radio wave from the antenna element 106 is reflected on a surface of the medium and not propagated through the medium. Since the second insulation layer 1101 prevents the radio wave from being reflected by the medium, it lets the radio wave propagate smoothly into the medium.

Therefore, the antenna element 106 with the second insulation layer 1101 can radiate the radio wave to the medium such as soil, water, and human body.

The antenna device may be used for ground penetrating radar apparatus, and human-body communication apparatus.

Moreover, the antenna device realizes both low profile and variable direction as same as the first embodiment.

The antenna devices according to the first to third embodiments can be used for wireless communication apparatus, radar apparatus, imaging apparatus, and wireless power transfer apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An antenna device comprising:
a reflector plate;
plane conductors arranged regularly on a plane which is parallel to the reflector plate;
an antenna element set on the plane, to be parallel to the reflector plate;
variable impedance elements which provide a directivity to the antenna element, the directivity being radiating a wave strongly to a particular direction;
control wires, each supplying a control signal to each of the variable impedance elements; and
linear conductors provided for some plane conductors, each connecting each of some plane conductors with the reflector plate,
wherein each of the other plane conductors is connected to the reflector plate through a portion of each control wire instead of the linear conductor.

2. The antenna device of claim 1, wherein
the variable impedance element changes a direction of a maximum radiation of the antenna element by changing a phase of a high frequency current through the antenna element.

3. The antenna device of claim 1, further comprising:
a first insulation layer which touches a side of the antenna element, the side being faced with the reflector plate; and
a second insulation layer which touches the other side of the antenna element, the other side being not faced with the reflector plate.

4. An antenna device comprising:
an EBG ground plane including linear-shaped conductors;
an antenna element;
variable impedance elements which provide a variable characteristic to the antenna element; and
control wires, each supplying a control signal to each variable impedance element, wherein
at least one of linear-shaped conductor has an inside space to keep a part of one of control wires.

5. The antenna device of claim 4, wherein
each control wire has an inner conductor and an outer conductor covering the inner conductor, the inner conductor carrying the control signal to the variable impedance element, and wherein
the linear-shaped conductor keeps the inner conductor into the inside space.
